(19) United States
(12) Patent Application Publication
(10) Pub. No.: US 2026/0184216 A1
(43) Pub. Date: Jul. 2, 2026

(54) APPARATUS, SYSTEM, AND METHOD FOR CONTROLLING CHARGING OF A VEHICLE

(71) Applicants: HYUNDAI MOTOR COMPANY, Seoul (KR); KIA CORPORATION, Seoul (KR)

(72) Inventors: Yo Han Baek, Hwaseong-si (KR); Jun Beom Wi, Hwaseong-si (KR); Sang Do Park, Hwaseong-si (KR)

(73) Assignees: HYUNDAI MOTOR COMPANY, Seoul (KR); KIA CORPORATION, Seoul (KR)

(21) Appl. No.: 19/211,707

(22) Filed: May 19, 2025

(30) Foreign Application Priority Data
Dec. 30, 2024 (KR) 10-2024-0201052

(51) Int. Cl. B60L 53/62; B60L 15/00; B60L 53/22; B60L 53/66

(52) U.S. Cl. CPC B60L 53/62; B60L 53/22; B60L 53/66; B60L 15/007

(57) ABSTRACT

A vehicle charging control apparatus includes a storage configured to store algorithms; and a processor configured, by executing the algorithms, to control a vehicle to pause a charging of the vehicle, generate a discharge pulse by using a battery of the vehicle, and control the vehicle to continue the charging of the vehicle based on discharge pulse.

### CROSS-REFERENCE TO RELATED APPLICATION

This application claims the priority to and the benefit of Korean Patent Application No. 10-2024-0201052, filed with the Korean Intellectual Property Office on Dec. 30, 2024, the entire contents of which are incorporated herein by reference.

### TECHNICAL FIELD

The present disclosure relates to a vehicle charging control apparatus, a vehicle charging control system, and a vehicle charging control method. More particularly, the present disclosure relates to a technique for improving rapid charging performance by applying a discharge pulse during charging.

### BACKGROUND

A plug-in electric vehicle may use electricity as a power source and may receive a power directly from a power source. An electric vehicle includes a battery configured to store an electric energy and a power each component of the vehicle, and the battery may be charged directly from a power source.

A charging method of a battery may be generally divided into rapid charging and slow charging. The rapid charging may be a method of charging a battery using a direct current, while the slow charging may be a method of charging a battery using an alternating current.

During rapid charging, polarization may occur due to a large current supplied to the battery. This may increase heat generation and increase a charging time.

To overcome shortcomings of this rapid charging method, a discharge pulse current may be used. However, although there is a means (cabin air conditioning device) capable of discharging a small current for a long time inside a vehicle, there may be a problem in that there is no means capable of discharging a large current of tens of amperes for a short time. The subject matter described in this background section is intended to promote an understanding of the background of the disclosure and thus may include subject matter that is not already known to those of ordinary skill in the art.

### SUMMARY

The present disclosure aims to provide a vehicle charging control apparatus, a vehicle charging control system, and a vehicle charging control method capable of reducing a charging time and extending a lifespan of a vehicle battery by generating a discharge pulse within the vehicle during rapid charging of the vehicle to eliminate a polarization phenomenon of the vehicle battery.

Furthermore, the present disclosure aims to provide a vehicle charging control apparatus, a vehicle charging control system, and a vehicle charging control method capable of improving rapid charging performance by controlling a switch in a vehicle to generate a discharge pulse during rapid charging.

Furthermore, the present disclosure aims to provide a vehicle charging control apparatus, a vehicle charging control system, and a vehicle charging control method capable of improving rapid charging performance by controlling a switch within a charger to generate a discharge pulse during rapid charging.

The technical objects of the present disclosure are not limited to the objects mentioned above, and other technical objects not mentioned should be clearly understood by those having ordinary skill in the art from the present disclosure.

An embodiment of the present disclosure provides a vehicle charging control apparatus including a storage configured to store algorithms. The vehicle charging control apparatus further includes a processor configured to: control a vehicle to pause a charging of the vehicle; generate a discharge pulse by using a battery of the vehicle; and control the vehicle to continue the charging of the vehicle based on the discharge pulse.

In an embodiment of the present disclosure, the processor may be configured to determine whether the discharge pulse exists within a target charging current provided from a charger based on a case where a charging progress condition is satisfied.

In an embodiment of the present disclosure, the processor may be configured, based on a case where the discharge pulse exists within the target charging current, to pause the charging of the vehicle and generate the discharge pulse using the battery.

In an embodiment of the present disclosure, the processor may be configured, based on a case where the discharge pulse exists within the target charging current, to request the charger to provide the target charging current as a zero current.

In an embodiment of the present disclosure, the processor may be configured to request the charger to open a charger-side switch provided in the charger configured to control current supply from the charger to the vehicle.

In an embodiment of the present disclosure, the processor may be configured to start discharging; and determine a target discharge current according to a discharge profile.

In an embodiment of the present disclosure, the processor may be configured to determine revolutions per minute (RPM) for providing the target discharge current based on current, voltage, and RPM profiles.

In an embodiment of the present disclosure, the processor may be configured to determine a target motor driving value for driving a motor to provide the target discharge current based on the determined RPM.

In an embodiment of the present disclosure, the processor may be configured to discharge an inverter and a motor based on the target motor driving value.

In an embodiment of the present disclosure, the processor may be configured, after generating the discharge pulse, to close a switch of a pre-charge circuit for preventing an overcurrent between a battery and a charger.

In an embodiment of the present disclosure, the processor may be configured to provide a target charging voltage for charging to the charger; and request the charger to open a charger-side switch provided in the charger configured to control current supply from the charger to the vehicle.

In an embodiment of the present disclosure, the processor may be configured to determine that a voltage and a current provided from the charger to the battery are in a stable state based on a case where the voltage and the current are equal to or less than predetermined levels.

In an embodiment of the present disclosure, the processor may be configured to open the switch of the pre-charge circuit based on the voltage and the current provided from the charger to the battery that are stabilized.

In an embodiment of the present disclosure, the processor may be configured to transfer a target charging voltage for charging to the charger; and request constant voltage control from the charger.

In an embodiment of the present disclosure, the processor may be configured to request the charger to open a vehicle-side switch provided in the vehicle. The charger is configured to control current supply from the charger to the vehicle.

In an embodiment of the present disclosure, the processor may be configured, after generating a discharge pulse using the battery while the vehicle-side switch is open; close the switch of the pre-charge circuit to prevent an overcurrent between the battery and the charger; provide a target charging voltage for charging to the charger; and request constant voltage control from the charger.

An embodiment of the present disclosure provides a system including a battery configured to provide a voltage for driving a vehicle. The system further includes a first inverter configured to provide a voltage received from a charger to the battery. The system further includes a second inverter configured to provide a voltage to the motor. The system further includes a processor configured to control a vehicle to pause a charging of the vehicle; generate a discharge pulse by using the battery of the vehicle; control the vehicle to continue the charging of the vehicle based on the discharge pulse.

In an embodiment of the present disclosure, the vehicle may include a first switch provided between the memory and the first inverter; and a second switch provided between the first inverter and the charger.

In an embodiment of the present disclosure, the system may further include a third switch and a resistor element connected in series between the battery and the first inverter, and the third switch and the resistor element may be connected in parallel with the first switch.

An embodiment of the present disclosure provides a vehicle charging control method including controlling, by a processor, a vehicle to pause a charging of the vehicle; generating, by the processor, a discharge pulse by using a battery; and controlling, by the processor, the vehicle to continue the charging of the vehicle based on completion of generation of the discharge pulse.

According to the present disclosure, it may be possible to shorten the charging time and extend the lifespan of the vehicle battery by generating a discharge pulse inside the vehicle during rapid charging to eliminate the polarization phenomenon of the vehicle battery.

Furthermore, according to the present disclosure, it may be possible to improve rapid charging performance by controlling a switch within a vehicle or a switch within a charger to generate a discharge pulse within the vehicle.

Furthermore, various effects, which may be directly or indirectly identified through the present disclosure, may be provided.

### BRIEF DESCRIPTION OF THE DRAWINGS

FIG. 1 illustrates a schematic diagram showing an example configuration of a vehicle charging control system.

FIG. 2 illustrates a block diagram showing an example configuration of a charging control apparatus.

FIG. 3 illustrates an example diagram of charging current and discharging current waveforms.

FIG. 4 illustrates an example of changes in battery voltage.

FIG. 5A illustrates an example current flow in a charging state.

FIG. 5B illustrates an example current flow in a discharging state.

FIG. 5C illustrates an example of an incorrect discharge current path.

FIG. 6 illustrates a flowchart for describing an example vehicle charging control method.

FIG. 7 illustrates an example flowchart for specifically describing a vehicle charging control method using a discharge pulse.

FIG. 8 illustrates another example flowchart for specifically describing a vehicle charging control method using a discharge pulse.

FIG. 9 illustrates an example charge time for a current profile.

FIG. 10 illustrates an example view for describing a depolarization effect due to an increase in discharge pulse current.

FIG. 11 illustrates a view for describing a battery lifespan extension effect due to a pulse discharge current.

FIG. 12 illustrates an example computing system.

### DETAILED DESCRIPTION

Hereinafter, some embodiments of the present disclosure are described in detail with reference to drawings. It should be noted that when reference numerals to constituent elements of each drawing are added, the same or equivalent constituent elements include the same reference numerals as possible even though the constituent elements are indicated on different drawings. In describing an embodiment of the present disclosure, when it is determined that a detailed description of the well-known configuration or function associated with the embodiment of the present disclosure may obscure the gist of the present disclosure, the detailed description may be omitted.

In describing constituent elements according to an embodiment of the present disclosure, terms, such as first, second, A, B, (a), and (b), may be used. These terms are only for distinguishing the constituent elements from other constituent elements, and the nature, sequences, or orders of the constituent elements are not limited by the terms. Furthermore, all terms used herein including technical scientific terms have the same meanings as those which are generally understood by those having ordinary skill in the technical field to which an embodiment of the present disclosure pertains (those having ordinary skill in the art) unless the terms are differently defined. Terms defined in a generally used dictionary shall be construed to have meanings matching those in the context of a related art and shall not be construed to have idealized or excessively formal meanings unless the terms are clearly defined in the present disclosure. When a controller, apparatus, module, component, device, element, or the like of the present disclosure is described as having a purpose or performing an operation, function, or the like, the controller, apparatus, module, component, device, element, or the like should be considered herein as being “configured to” meet that purpose or to perform that operation or function. Each controller, apparatus, module, component, device, element, and the like may separately embody or be included with a processor and a memory, such as a non-transitory computer readable media, as part of the apparatus.

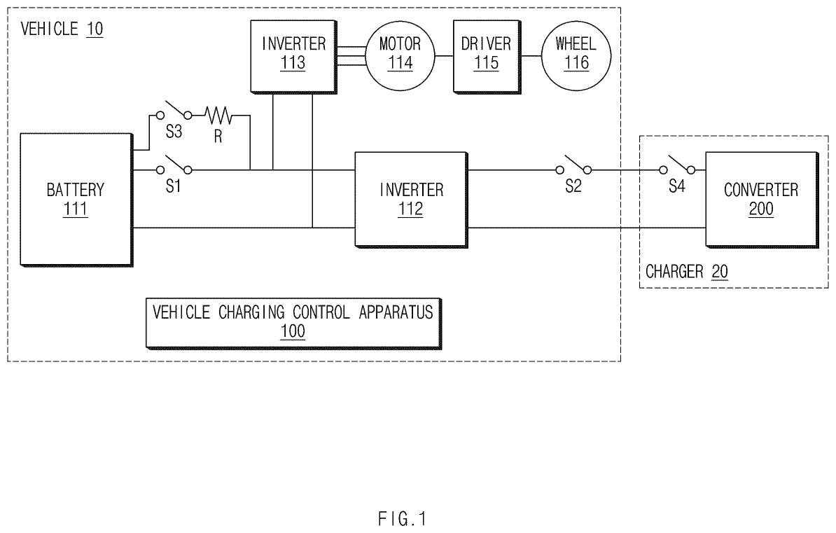

Hereinafter, various embodiments of the present disclosure are described in detail with reference to FIG. 1-FIG. 12.

FIG. 1 illustrates a schematic diagram showing an example configuration of a vehicle charging control system.

Referring to FIG. 1, the vehicle charging control system according to an embodiment of the present disclosure may include a vehicle 10 and a charger 20.

The vehicle 10 may include an electric vehicle (EV) that requires charging, an eco-friendly vehicle, a plug-in hybrid electric vehicle (PHEV), a hybrid electric vehicle (HEV), a ship, an airplane, an urban air mobility (UAM), an electric kickboard, and the like.

The vehicle 10 may include a battery 111, inverters 112 and 113, a motor 114, a driver 115, a wheel 116, a plurality of switches S1, S2, S3, and S4, a resistor R, and a vehicle charging control apparatus 100.

The battery 111 may supply a power to the vehicle and may include a high-voltage battery that is charged by an external charger 20 during charging. In FIG. 1, only the battery 111 is illustrated, but the battery 111 may be implemented as a battery system assembly (BSA) that includes the battery, a battery management system (BMS), a relay, a fuse, and the like.

The inverters 112 and 113 may convert an alternating current to a direct current power during the charging and discharging of the high-voltage battery.

The motor 114 may be driven to drive the vehicle, and the driver 115 may drive the wheel 116 and may perform connection to or disconnection from the wheel 116. In the instant case, the driver 115 may include a disconnector actuator system (DAS).

The charger 20 may include a rapid charger, and the vehicle 10 may rapidly charge the battery 111 by receiving a voltage supplied from the charger 20.

The switch S1 may be connected between the battery 111 and the inverter 112 to control connection between the battery 111 and the inverter 112, and the switch S2 may be provided at an output terminal of the inverter 112 to control connection with the charger 20.

The switch S3 and the resistor R may be connected in series between the battery 111 and the inverter 112. In the instant case, the switch S3 may be connected in parallel with the switch S1 and may operate as a pre-charge circuit.

In other words, in response to a case where a large current is applied through the inverter 112 during rapid charging, the switch S3 may be closed and the switch S1 may be opened to prevent damage to components, and thus the large current applied from a side of the inverter 112 may pass through the resistor R3, thereby reducing the current.

The charger 20 may include a converter 200 and a switch S4.

The converter 200 may be a unidirectional converter that steps up a voltage, and the switch S4 may control connection between the vehicle 10 and the converter 200.

The vehicle charging control apparatus 100 within a vehicle may be configured to improve performance of rapid charging by using a discharge pulse during rapid charging of the vehicle 10.

The vehicle charging control apparatus 100 may be configured to include at least one of a battery management unit (BMU), a vehicle charging management system (VCMS), a micro controller unit (MCU), or a vehicle control unit (VCU).

According to an embodiment of the present disclosure, the vehicle charging control apparatus 100 may be implemented within or separately from a vehicle. In this case, the vehicle charging control apparatus 100 may be integrally formed with internal control units of the vehicle or may be implemented as a separate hardware device to be connected to control units of the vehicle by a connection means. For example, the vehicle charging control apparatus 100 may be implemented integrally with the vehicle or may be implemented in a form that is installed or attached to the vehicle as a configuration separate from the vehicle. Alternatively, a part of the vehicle charging control apparatus 100 may be implemented integrally with the vehicle, and another part of the vehicle charging control apparatus 100 may be implemented in a form that is installed or attached to the vehicle as a configuration separate from the vehicle.

The vehicle charge control apparatus 100 may be configured to improve performance of rapid charging by controlling the vehicle to temporarily stop charging during rapid charging of the vehicle and then continue rapid charging after generating a discharge pulse.

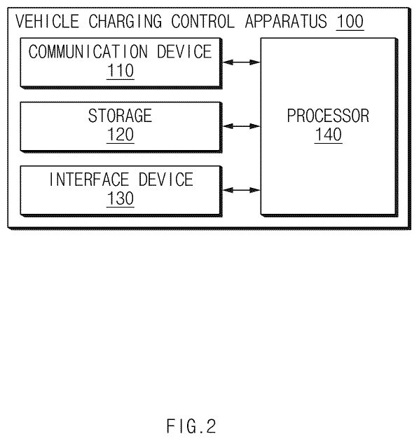

FIG. 2 illustrates a block diagram showing an example configuration of a charging control apparatus.

The vehicle charging control apparatus 100 may be configured to include a communication device 110, a storage 120, an interface device 130, and a processor 140. According to an embodiment of the present disclosure, the vehicle charging control apparatus 100 may be implemented as a single body by coupling components with each other, and some components may be omitted.

The communication device 110 may be a hardware device implemented with various electronic circuits to transmit and receive signals through a wireless or wired connection and may be configured to transmit and receive information based on in-vehicle devices and in-vehicle network communication techniques. As an embodiment of the present disclosure, the in-vehicle network communication techniques may include Controller Area Network (CAN) communication, Local Interconnect Network (LIN) communication, flex-ray communication, and the like.

The communication device 110 is a hardware device implemented with various electronic circuits to transmit and receive signals through a wireless or wired connection and may transmit and receive information with internal devices such as vehicles, ships, airplanes, urban air mobilities (UAM), and electric kickboards based on network communication techniques. As an embodiment of the present disclosure, the in-vehicle network communication techniques may include Controller Area Network (CAN) communication, Local Interconnect Network (LIN) communication, flex-ray communication, and the like.

The communication device 110 may be configured to perform vehicle-to-everything (V2X) communication. The V2X communication may include communication between vehicle and all entities, such as vehicle-to-vehicle (V2V) communication, vehicle to infrastructure (V2I) communication, vehicle-to-pedestrian (V2P) communication, and vehicle-to-network (V2N) communication. The V2V communication refers to communication between vehicles. The V2I communication refers to communication between a vehicle and an Evolved Node B (eNB) or road side unit (RSU). The V2P communication refers to communication between user equipment (UE) held by vehicles and individuals (pedestrians, cyclists, vehicle drivers, or occupants).

Furthermore, the communication device 110 may include a mobile communication module, a wireless Internet module, a short-range communication module, etc. for communication with outside of the vehicle.

The mobile communication module may be configured to perform communication using technical standards or communication methods for mobile communication (e.g., Global System for Mobile communication (GSM), Code Division Multi access (CDMA), Code Division Multi Access 2000 (CDMA 2000), Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), Long Term Evolution (LTE), Long Term Evolution-Advanced (LTE-A), 4th Generation mobile telecommunication (4G), 5th Generation mobile telecommunication (5G), and the like).

The wireless Internet module refers to a module for wireless Internet access and may be configured to perform communication through Wireless LAN (WLAN), Wireless-Fidelity (Wi-Fi), Wi-Fi direct, Digital Living Network Alliance (DLNA), Wireless Broadband (WiBro), World Interoperability for Microwave Access (WiMAX), High Speed Downlink Packet Access (HSDPA), High Speed Uplink Packet Access (HSUPA), Long Term Evolution (LTE), Long Term Evolution-Advanced (LTE-A), and the like.

The short-range communication module may support short-range communication by using at least one of Bluetooth™, radio frequency identification (RFID), infrared data association (IrDA), ultra wideband (UWB), ZigBee, near field communication (NFC), a wireless universal serial bus (USB) technique, or any combination thereof. For example, the communication device 110 may be configured to provide charging-related information (charging station, charging amount, charging time, cost, and the like.) to a user terminal.

The storage 120 may store data and/or algorithms required for the processor 140 to operate, and the like.

For example, the storage 120 may be configured to store a target state of charge (SOC) for determining charging progress condition, revolutions per minute (RPM) determined by the processor 140, a target motor driving value, etc. The storage 120 may include a storage medium of at least one type among memories of types, such as a flash memory, a hard disk, a micro, a card (e.g., a secure digital (SD) card, an extreme digital (XD) card), a random access memory (RAM), a static RAM (SRAM), a read-only memory (ROM), a programmable ROM (PROM), an electrically erasable PROM (EEPROM), a magnetic memory (MRAM), a magnetic disk, and an optical disk.

The interface device 130 may include an input means for receiving a control command from a user and may include an output means for outputting an operation state of the apparatus 100 and results thereof. Herein, the input means may include a key button and may include a mouse, a joystick, a jog shuttle, a stylus pen, and the like. Furthermore, the input means may include a soft key implemented on the display.

The interface device 130 may be implemented as a head-up display (HUD), a cluster, an audio video navigation (AVN), or a human machine interface (HM), or a human machine interface (HMI).

The output device may include a display and may also include a voice output means such as a speaker. In the instant case, in a response to a case that a touch sensor formed of a touch film, a touch sheet, or a touch pad is provided on the display, the display may operate as a touch screen, and may be implemented in a form in which an input device and an output device are integrated. In the present disclosure, the output device may output a charging status, a charging amount, a charging time, a charging cost, and the like.

In the instant case, the display may include at least one of a liquid crystal display (LCD), a thin film transistor liquid crystal display (TFT LCD), an organic light emitting diode display (OLED display), a flexible display, a field emission display (FED), or a 3D display.

The processor 140 may be electrically connected to the communication device 110, the storage 120, and the interface unit 130, etc. and configured to perform overall control such that each component may normally perform its function. Furthermore, the processor 140 may be an electrical circuit that may be configured to electrically control each component and to execute a command of software, thereby performing various data processing and calculations to be described below.

The processor 140 may be implemented in the form of hardware, software, or a combination of hardware and software. For example, the processor 140 may be implemented as a microprocessor, but the present disclosure is not limited thereto. For example, the processor 140 may be, e.g., an electronic control unit (ECU), a micro controller unit (MCU), or other subcontrollers mounted in the vehicle.

The processor 140 may be implemented with an application specific integrated circuit (ASIC), a digital signal processor (DSP), a programmable logic device (PLD), a field programmable gate array (FPGA), a central processing unit (CPU), a microcontroller, a microprocessor and/or the like.

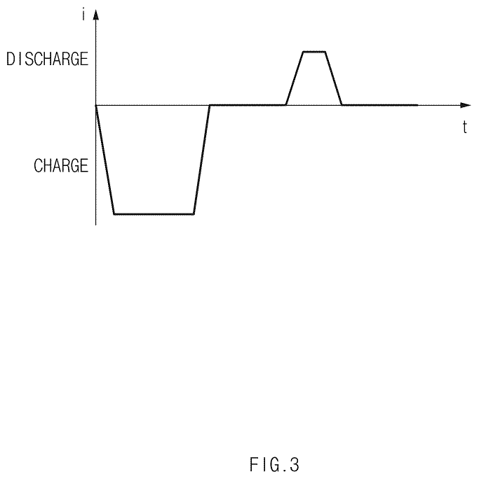

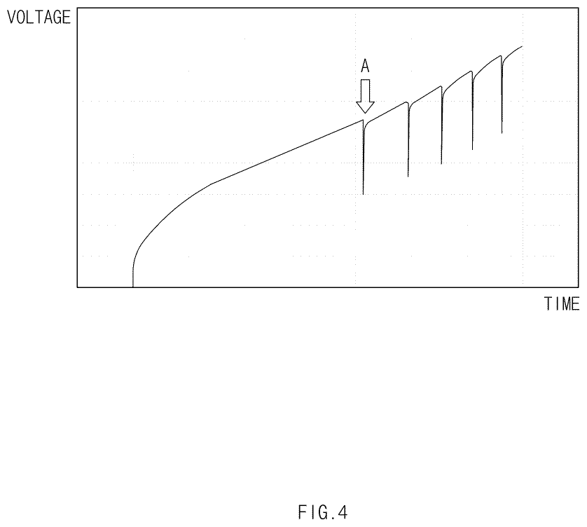

The processor 140 may be configured to determine whether a discharge pulse exists within a target charging current provided from the charger 20 in response to a case where the charging progress condition is satisfied. The discharge pulse may include a waveform as in FIG. 3, and as the discharge pulse exists within the target charging current, a voltage may drop as in A of FIG. 4. FIG. 3 illustrates an example diagram of charging current and discharging current waveforms, and FIG. 4 illustrates an example of changes in battery voltage.

In response to a case where the discharge pulse exists within the target charging current, the processor 140 may be configured to temporarily stop charging and may generate a discharge pulse using the battery 111, the inverter 113, the motor 114, and the driver 115.

During charging, a current of the charger 20 may be supplied to the battery 111, and during discharging, a current of the battery 111 may be discharged through the motor 114 and the driver 115.

However, due to a discharge path error, the current of the charger 20 may be discharged through the inverter 113, the motor 114, and the driver 115, and in response to a case where this discharge pulse is included in the target charging current (current provided from the charger), the processor 140 may be configured to request that a target current of the charger 20 be provided as zero current. In other words, the charger 20 may be prevented from providing a current to the battery 111.

The processor 140 may be provided in the charger and configured to request the charger 20 to open the charger-side switch S4 that controls current supply from the charger 20 to the vehicle 10. In response to a case where the charger-side switch S4 is opened, the processor 140 may be configured to start discharge and determine a target discharge current according to a discharge profile. In the instant case, the discharge profile may be determined in advance by experimental values, and the target discharge current according to the discharge profile may be determined based on a current battery SOC, and the like.

The processor 140 may be configured to determine RPM to provide the target discharge current based on current, voltage, and RPM profiles. In other words, the processor 140 may be configured to determine the RPM for providing the target discharge current and determine a target motor drive value for driving the motor to provide the target discharge current based on the determined RPM. Accordingly, the motor 114 may be driven based on the target motor drive value during discharge.

The processor 140 may be configured to drive the inverter and the motor to discharge based on the target motor drive value. After generation of the discharge pulse is completed, the processor 140 may be configured to close the switch S3 of the pre-charge circuit for preventing an overcurrent between the battery 111 and the charger 20. In the instant case, the switch S2 may be opened to allow the current provided from the charger 20 to pass through the resistor R.

The processor 140 may be configured to provide a target charging voltage for charging to the charger 20 and request the charger 20 to close the charger-side switch S4, which is provided in the charger 20 and controls current supply from the charger 20 to the vehicle 10.

The processor 140 may be configured to determine that a voltage and a current provided from the charger 20 to the battery 111 are in a stabilized state in response to a case where the voltage and the current are equal to or less than predetermined levels after the charger-side switch S4 is closed. In other words, in a case where rapid charging is restarted immediately after the discharge pulse occurs, a difference in a current gap between the battery 111 and the charger 20 may be significant, so the pre-charge circuit may be used to reduce the current gap, and once the difference in the current gap between the battery 111 and the charger 20 may be reduced and stabilized, the switch S3 may be opened and the switch S1 may be closed as before to receive a current from the charger 20 and perform charging.

In other words, in response to a case where the voltage and the current provided from the charger 20 to the battery 111 are stabilized, the processor 140 may be configured to open the switch S3 of the pre-charge circuit, transfer the target charging voltage for charging to the charger 20, and request constant voltage control from the charger 20.

The processor 140 may be provided in the vehicle 10 and configured to request the charger 20 to open the vehicle-side switch S2 that controls the current supply from the charger 20 to the vehicle. The processor may be configured to, while the vehicle-side switch S2 is open, generate a discharge pulse using the battery 111 and then close the switch S3 of the pre-charge circuit for preventing an overcurrent between the battery 111 and the charger 20. The processor may be configured to provide the target charging voltage for charging to the charger 20 and request constant voltage control from the charger 20.

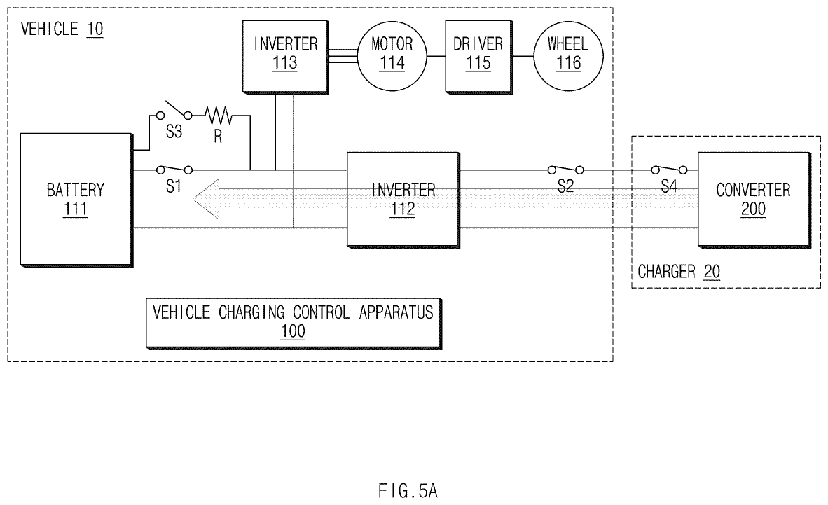

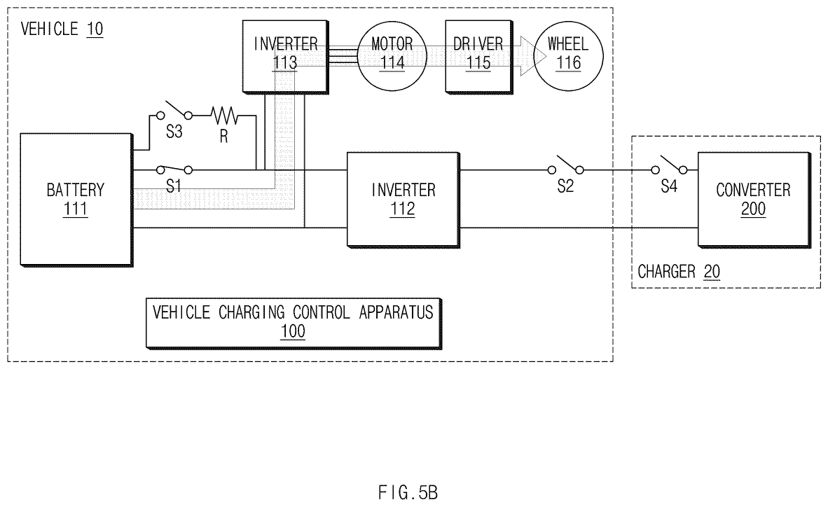

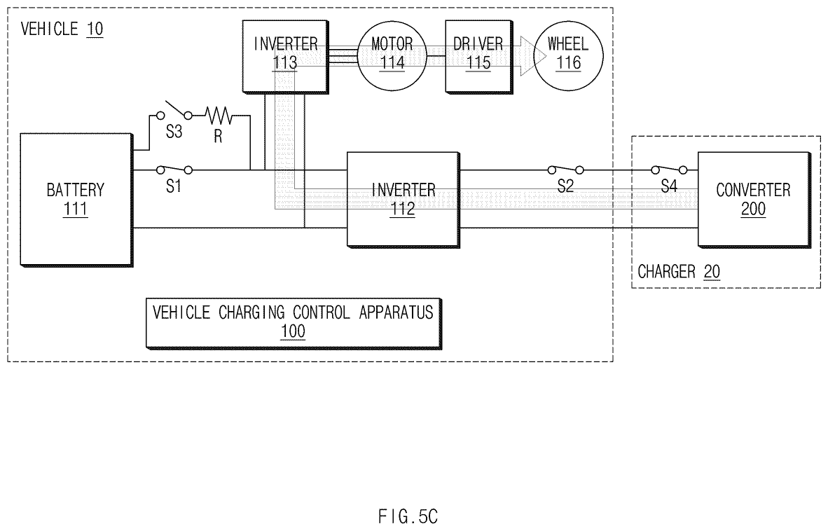

FIG. 5A illustrates an example current flow in a charging, FIG. 5B illustrates an example current flow in a discharging, and FIG. 5C illustrates an example of an incorrect discharge current path.

During charging, as illustrated in FIG. 5A, switches S1, S2, and S4 may all be closed, so a current from the charger 20 may be supplied to the battery 111.

In FIG. 5B, a correct discharge pulse generation path is illustrated as a path through which a current of the battery 111 is discharged through the inverter 113, the motor 114, and the driver 115. In FIG. 5C, an incorrect discharge pulse generation path is illustrated as a path through which a current provided from the charger 20 is discharged through the inverter 113, the motor 114, and the driver 115.

In the present disclosure, to prevent the incorrect discharge pulse generation path as shown in FIG. 5C, the switch S2 on a side of the vehicle or the switch S4 on a side of the charger may be controlled before generation of a discharge pulse, so as to change a closed circuit formed by a current provided from the charger 20 through the inverter 113, the motor 114, and the driver 115 into an open circuit, thereby securing a correct discharge path.

Furthermore, by controlling the switch S2 on the side of the vehicle or switch S4 on the side of the charger, the closed circuit formed by the current provided from the charger 20 through the inverter 113, the motor 114, and the driver 115 may be changed to the open circuit, thereby preventing an overcurrent that may occur in response to restarting rapid charging using the switch S3 and the resistor R after the discharge pulse is generated.

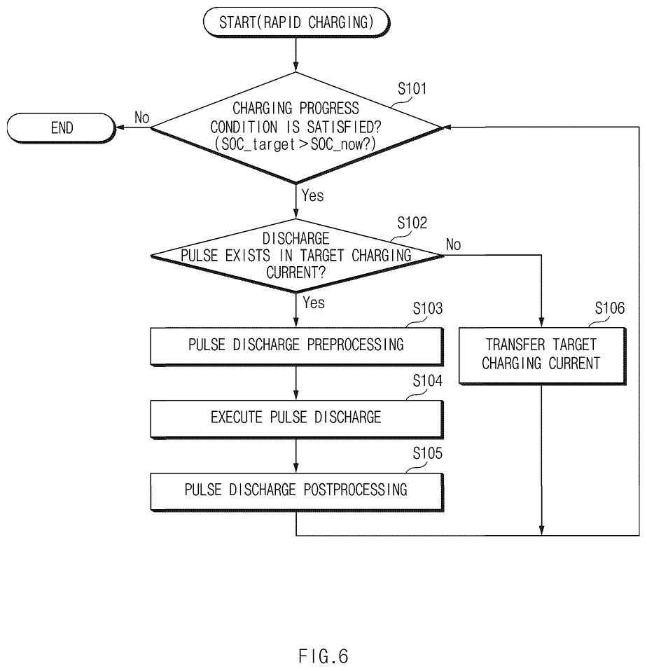

Hereinafter, a vehicle charging control method according to an embodiment of the present disclosure is described in detail with reference to FIG. 6-FIG. 8.

FIG. 6 illustrates a flowchart for describing an example vehicle charging control method. Hereinafter, it is assumed that the vehicle charging control apparatus 100 of FIG. 1 performs processes of FIG. 6. In addition, in the description of FIG. 6, operations described as being performed by a device may be understood as being controlled by the processor 140 of the vehicle charging control apparatus 100. In the following embodiments, operations S101-S106 may be performed sequentially but are not necessarily performed sequentially. For example, an order of each operation may be changed, and at least two operations may be performed in parallel.

Referring to FIG. 6, the vehicle charging control apparatus 100 may be configured to determine whether a charging progress condition is satisfied after rapid charging starts (S101). In the instant case, the vehicle charging control apparatus 100 may be configured to determine whether a predetermined target SOC (SOC_target) is greater than a current SOC (SOC_now) of a battery. The vehicle charging control apparatus 100 may be configured to determine that the rapid charging is not necessary in response to a case where the predetermined target SOC (SOC_target) is not greater than the current SOC (SOC_now) of the battery (No in S101) (i.e., the current SOC (SOC_now) of the battery is equal to or greater than the predetermined target SOC (SOC_target)). Thus, the rapid charging may be ended.

In a case where the predetermined target SOC (SOC_target) is greater than the current SOC (SOC_now) of the battery (Yes in S101), the vehicle charging control apparatus may be configured to determine that the rapid charging is required, and determine whether a discharge pulse exists within a target charging current (S102). This is to determine a case where the target charging current provided from the charger 20 is discharged, as in FIG. 5C. Accordingly, in a case where a discharge pulse exists in the target charging current, a point occurs where a charging voltage drops, as in A of FIG. 4. Therefore, according to the present disclosure, it may be possible to improve charging performance by generating a discharge pulse using the battery 111 as shown in FIG. 5B.

In the instant case, the target charging current may be an amount of current required for charging and may be the current supplied from the charger 20 to the battery 1110 of the vehicle 10, and the target charging current for each SOC may be determined in advance and may be arbitrarily set by a user during charging. As illustrated in FIG. 5A, a voltage from the converter 200 may be supplied to the battery 111 through the inverter 112 and charged.

The vehicle charging control apparatus 100 may be configured to monitor a charging current (target charging current level) applied to the battery 111 from the charger 20 and, in response to case where a point where the charging current suddenly drops occurs, determine that a discharge current has occurred. FIG. 4 illustrates a change in a voltage and illustrates a point A where the voltage suddenly drops may be determined as a point where a discharge current occurs.

The vehicle charging control apparatus 100 may be configured to provide a target charging current to the charger 20 in response to a case where there is no discharge pulse within the target charging current (No in S102), so the target charging current may be continuously provided from the charger 20 (S106).

In response to a case where a discharge pulse exists within the target charging current (Yes in S102), the vehicle charging control apparatus 100 may be configured to perform pulse discharge preprocessing (S103), perform pulse discharge processing (S104), and then perform pulse discharge postprocessing (S105).

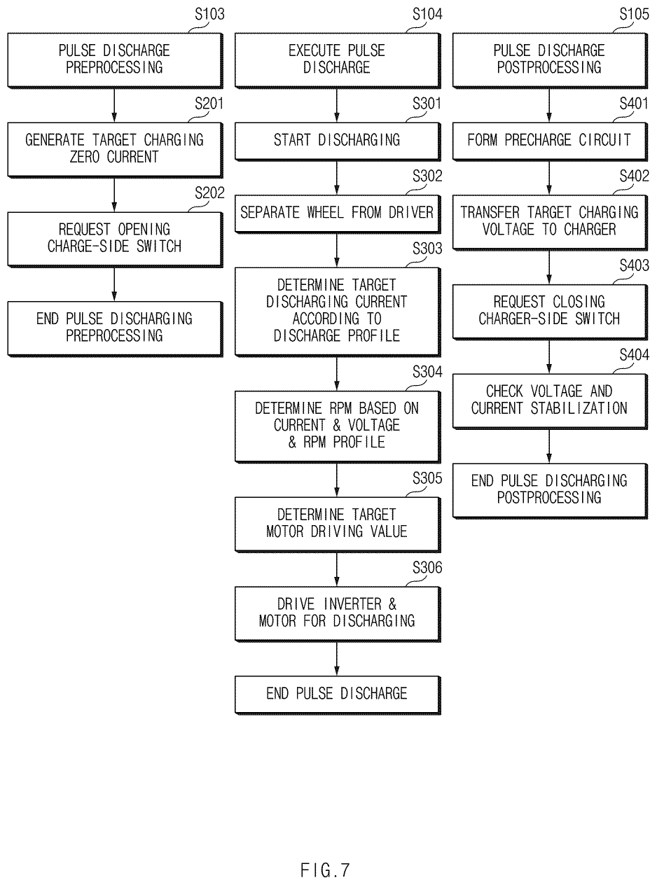

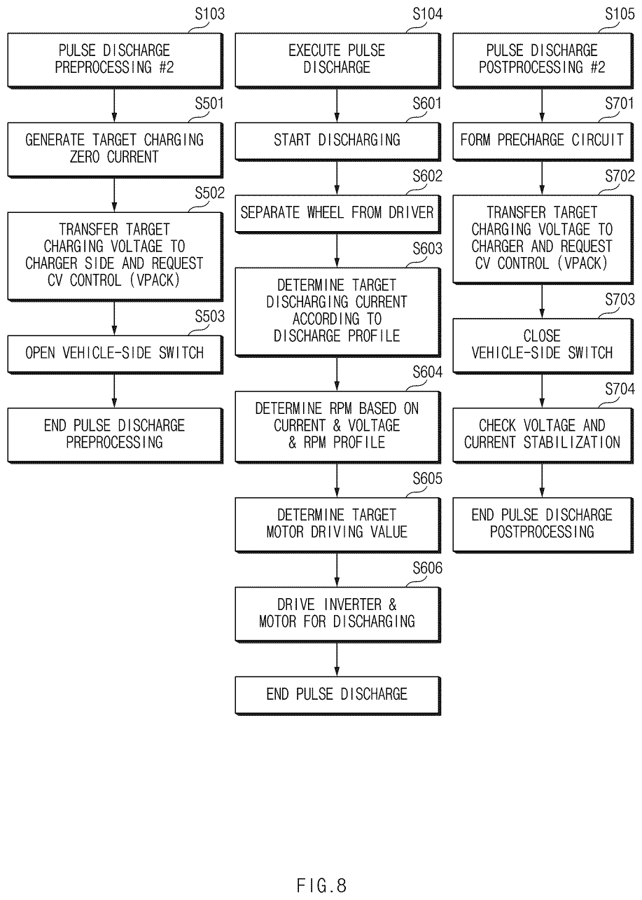

Pulse discharge preprocessing, pulse discharge execution, and pulse discharge postprocessing are specifically described below with reference to FIGS. 7 and 8.

FIG. 7 illustrates an example flowchart for specifically describing a vehicle charging control method using a discharge pulse. Hereinafter, it is assumed that the vehicle charging control apparatus 100 of FIG. 1 performs processes of FIG. 7. In addition, in the description of FIG. 7, operations described as being performed by a device may be understood as being controlled by the processor 140 of the vehicle charging control apparatus 100. In following embodiments, operations S201-S404 may be performed sequentially but are not necessarily performed sequentially. For example, an order of each operation may be changed, and at least two operations may be performed in parallel.

Referring to FIG. 7, to execute pulse discharge preprocessing (S103), the vehicle charging control apparatus 100 may be configured to first generate a target charging zero current and transmits the target charging zero current to the charger 20 (S201) for pulse discharge preprocessing. Then, the vehicle charging control apparatus 100 may be configured to request the charger 20 to open the switch S4 on a side of the charger (S202). Accordingly, the charger 20 may be configured to set the target charging current provided to the battery 111 to 0 and open the charger-side switch S4.

In this way, the vehicle charging control apparatus 100 may be configured to make a charging current provided by the charger 20 to the battery 111 zero current, thereby temporarily stopping the charging, before generating a discharge pulse, i.e., before opening the switch S4. This is to prevent the current supplied from the charger 20 from being discharged in a direction of the inverters 112 and 113, the motor 114, the driver 115, and the wheel 116, as shown in FIG. 5C. Accordingly, the current supplied from the charger 20 to the battery 111 may be made 0 before the discharge starts.

Next, to execute pulse discharge (S104), the vehicle charging control apparatus 100 may be configured to start discharging the battery (S301) and request separation of the wheel 116 from the driver 115 (S302). Accordingly, the driver 115 may be configured to disconnect connection with the wheel 116.

The vehicle charging control apparatus 100 may be configured to determine a target discharge current according to a prestored discharge profile (S303), and in the instant case, the discharge profile may be preset and stored by experimental values. The target discharge current may refer to the target current level in a case where the discharge current is generated.

The vehicle charging control apparatus 100 may be configured to RPM based on current, voltage, and RPM profiles (S304). In the instant case, the vehicle control apparatus 100 may be configured to determine the RPM to provide the target discharge current based on the current, voltage and RPM profiles.

Then, the vehicle charging control apparatus 100 may be configured to determine a target motor driving value based on the determined RPM (S305) and drive the inverter and the motor for discharge according to the target motor driving value (S306). As illustrated in FIG. 5B, the current output from the battery 111 is discharged through the inverter 113, the motor 114, and the driver 115.

As such, after generating the discharge pulse, the vehicle charging control apparatus 100 may be configured to perform pulse discharge postprocessing (S105).

The vehicle charging control apparatus 100 may be configured to form a pre-charge circuit by opening the switch S1 and closing the switch S3 (S401).

In other words, in a case where generation of the discharge pulse is ended, rapid charging of the vehicle 10 may have to be restarted by the charger 20. In the instant case, in a case where the rapid charging is restarted while the battery 111 is receiving zero current from the charger 20 in operation S201 and suddenly receives the target charging current from the charger 20, a current gap between the battery 111 and the charger 20 may increase, which may cause damage to the components. Accordingly, to prevent damage due to a large current from the charger 20, a pre-charge circuit may be configured.

In other words, in a case where the switch S1 is closed, the large current from the charger 20 may be directly applied to the battery 111, which may cause damage, so damage may be prevented by reducing the large current through the resistor R.

Thereafter, the vehicle charge control apparatus 100 may be configured to transmit a target charge voltage to the charger 20 (S402). In the instant case, the target charging voltage may indicate a target voltage to be charged.

Next, the vehicle charging control device 100 may be configured to request the charger 20 to close the charger-side switch S4, so the switch S4 may be closed (S403).

Next, the vehicle charging control apparatus 100 may be configured to check voltage and current stabilization (S404) and, in response to a case where the voltage and the current reach predetermined levels (target level), determine that the voltage and the current are stabilized, open the switch S3 of the pre-charge circuit, and close the switch S1 to continue rapid charging.

FIG. 7 illustrates an embodiment of generating a discharge pulse by controlling the switch S2 in the vehicle 10, and FIG. 8 illustrates a method of generating the discharge pulse by controlling the switch S4 in the charger 20.

FIG. 8 illustrates another example flowchart for specifically describing a vehicle charging control method using a discharge pulse. Hereinafter, it is assumed that the vehicle charging control apparatus 100 of FIG. 1 performs processes of FIG. 8. In addition, in the description of FIG. 8, operations described as being performed by a device may be understood as being controlled by the processor 140 of the vehicle charging control apparatus 100. In following embodiments, operations S501-S704 may be performed sequentially but are not necessarily performed sequentially. For example, an order of each operation may be changed, and at least two operations may be performed in parallel.

Referring to FIG. 8, to execute pulse discharge preprocessing (S103), the vehicle charging control apparatus 100 may be configured to first generate a target charging zero current and transfer the target charging zero current to the charger 20 (S501) for pulse discharge preprocessing. Accordingly, the charger 20 may be configured to set the target charging current provided to the battery 111 to 0.

Next, the vehicle charging control apparatus 100 may be configured to transfer the target charging voltage to the charger 20 and request constant voltage (CV) control (S502).

That is, the vehicle charging control apparatus 100 may be configured to request maintaining a constant voltage and remaining on standby, as the charger 20 will not be turned off and rapid charging will resume later.

In this process, in a case where the switch S4 on the side of the charger 20 is opened as shown in FIG. 7, the charger 20 may not perform CV control. However, in a case where the switch S2 inside the vehicle is opened as shown in FIG. 8, the charger 20 may provide a charging current to the vehicle 10, but the switch S2 may be blocked, so the charger 20 may be on standby while performing the CV control.

Next, the vehicle charging control apparatus 100 may be configured to open the vehicle-side switch S2 (S503) to end the pulse discharge preprocessing.

Thereafter, before a discharge pulse is generated, the vehicle charging control apparatus 100 may be configured to open the switch S2 to temporarily stop rapid charging and then generate the discharge pulse.

Next, to execute pulse discharge (S104), the vehicle charging control apparatus 100 may be configured to perform operations S601-S606 of FIG. 8, and these operations are identical to the operations S301-S306 of FIG. 7, so a detailed description thereof has been omitted.

Next, after generating the discharge pulse, the vehicle charging control apparatus 100 may be configured to perform pulse discharge postprocessing (S105).

The vehicle charging control apparatus 100 may be configured to form a pre-charge circuit by opening the switch S1 and closing the switch S3 (S701).

In other words, in a case where generation of the discharge pulse is ended, rapid charging of the vehicle 10 may have to be restarted by the charger 20. In the instant case, in a case where the rapid charging is restarted while the battery 111 is receiving zero current from the charger 20 in operation S501 and suddenly receives the target charging current from the charger 20, a current gap between the battery 111 and the charger 20 may increase, which may cause damage to the components. Accordingly, to prevent damage due to a large current from the charger 20, a pre-charge circuit may be configured.

In other words, in a case where the switch S1 is closed, the large current from the charger 20 may be directly applied to the battery 111, which may cause damage, so damage may be prevented by reducing the large current through the resistor R.

Thereafter, the vehicle charging control apparatus 100 may be configured to transfer the target charging voltage to the charger 20 and request the CV control (S702). In the instant case, the target charging voltage may indicate a target voltage to be charged.

Next, the vehicle charging control device 100 may be configured to request the charger 20 to close the charger-side switch S4, so the switch S4 may be closed (S703).

Next, the vehicle charging control apparatus 100 may be configured to check voltage and current stabilization (S704) and, in response to a case where the voltage and the current reach predetermined levels (target level), determine that the voltage and the current are stabilized and open the switch S3 of the pre-charge circuit and close the switch S1 to continue rapid charging.

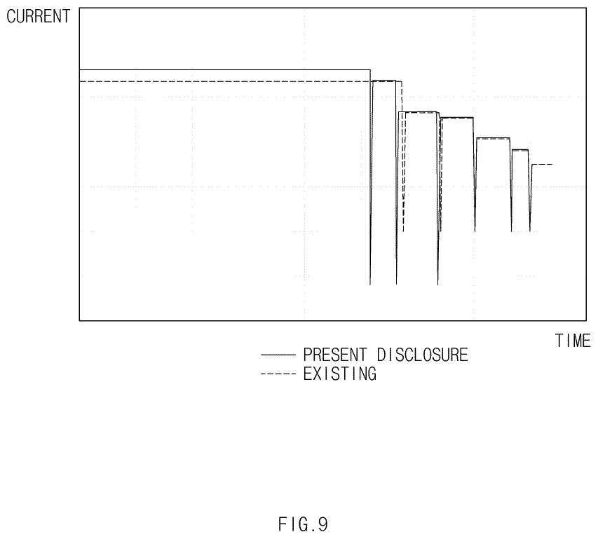

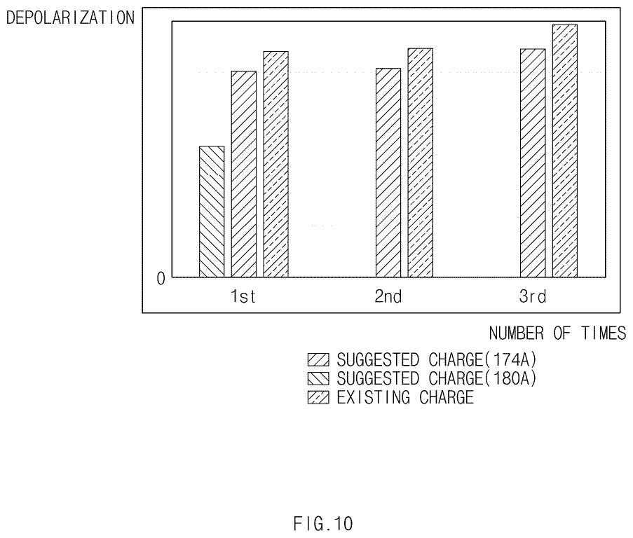

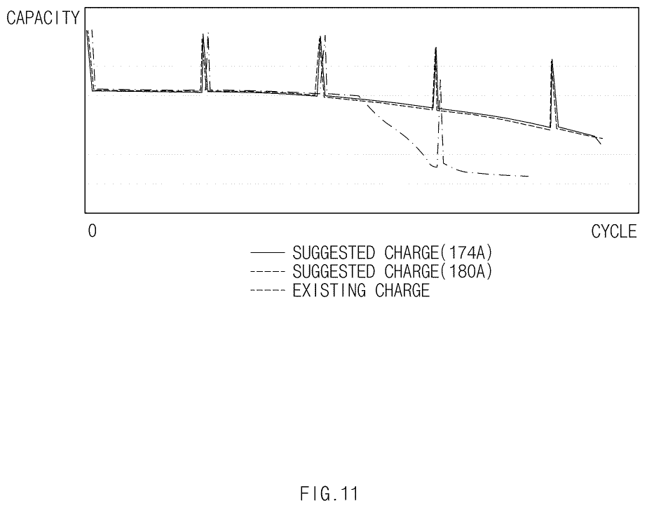

FIG. 9 illustrates an example charge time for a current profile, FIG. 10 illustrates an example view for describing a depolarization effect due to an increase in discharge pulse current, and FIG. 11 illustrates a view for describing a battery lifespan extension effect due to a pulse discharge current.

FIG. 9 illustrates a current profile and a charging time in a case where rapid charging is performed without generating a discharge pulse as in a conventional method and in a case where rapid charging is performed after generating the discharge pulse as in the present disclosure.

As illustrated in FIG. 9, it may be seen that the charging time is shorter in a case where the rapid charging is performed after generating the discharge pulse, as in the present disclosure, compared to the conventional method of performing the rapid charging without generating the discharge pulse.

Furthermore, FIG. 10 illustrates a bar graph comparing polarization release effects according to an increase in a discharge pulse current. Polarization may refer to a state in which charges inside and outside are divided based on a specific layer. In other words, in a chemical battery, movement of electrons and ions on an electrode surface may cause phenomena such as a temporary increase in a volume of the electrolyte or a coating of substances on the electrode surface, leading to a reduction in performance of the battery, which is called a polarization phenomenon. Accordingly, it may be necessary to reduce the polarization phenomenon, and in a case where the discharge pulse is 174 A and the discharge pulse is 180 A, the polarization phenomenon that occurs in the battery may be reduced compared to the polarization phenomenon that occurs in the battery in response to charging without the discharge pulse as before. In other words, it may be seen that as the discharge pulse current increases, a reduction in the polarization phenomena may become more significant.

FIG. 11 illustrates a life cycle of a battery according to the discharge pulse, and it may be seen that in a case of the discharge pulse of 174 A and in a case of the discharge pulse of 180 A, the lifespan of the battery is extended more than that of a conventional battery. In other words, in a case of repeating charging and discharging without generating the discharge pulse as in the conventional method, a cycle in which a battery capacity decreases is short, whereas in the case of repeating charging and discharging after generating the discharge pulse as in the present disclosure, a cycle in which the battery capacity decreases is longer.

In this way, according to the present disclosure, it may be possible to extend the lifespan of a battery, eliminate polarization, and reduce the charging time by generating a discharge pulse during rapid charging of the vehicle and then continuing the rapid charging. Furthermore, according to the present disclosure, an effect of eliminating the polarization phenomenon of the battery may be increased as a current magnitude of the discharge pulse generated during rapid charging of the vehicle increases.

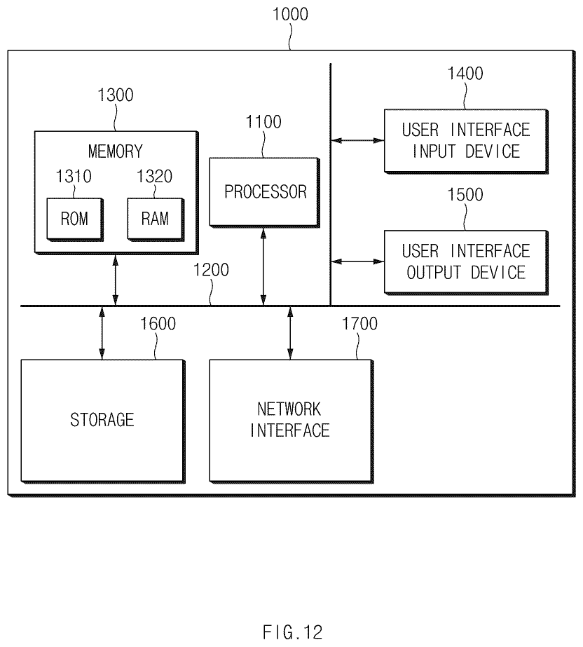

FIG. 12 illustrates an example computing system.

Referring to FIG. 12, the computing system 1000 includes at least one processor 1100 connected through a bus 1200, a memory 1300, a user interface input device 1400, a user interface output device 1500, and a storage 1600, and a network interface 1700.

The processor 1100 may be a central processing unit (CPU) or a semiconductor device that performs processing on commands stored in the memory 1300 and/or the storage 1600. The memory 1300 and the storage 1600 may include various types of volatile or nonvolatile storage media. For example, the memory 1300 may include a read only memory (ROM) 1310 and a random access memory (RAM) 1320.

Accordingly, steps of a method or algorithm described in connection with the embodiments included herein may be directly implemented by hardware, a software module, or a combination of the two, executed by the processor 1100. The software module may reside in a storage medium (i.e., the memory 1300 and/or the storage 1600) such as a RAM memory, a flash memory, a ROM memory, an EPROM memory, an EEPROM memory, a register, a hard disk, a removable disk, and a CD-ROM.

A storage medium is coupled to the processor 1100, which can read information from and write information to the storage medium. Alternatively, the storage medium may be integrated with the processor 1100. The processor and the storage medium may reside within an application specific IC (ASIC). The ASIC may reside within a user terminal. Alternatively, the processor and the storage medium may reside as separate components within the user terminal.

The above description merely illustrates the technical idea of the present disclosure, and those having ordinary skill in the art to which the present disclosure pertains may make various modifications and variations without departing from the essential characteristics of the present disclosure.

Therefore, the embodiments disclosed in the present disclosure are not intended to limit the technical ideas of the present disclosure, but to explain them, and the scope of the technical ideas of the present disclosure is not limited by these embodiments. The protection range of the present disclosure should be interpreted by the claims below, and all technical ideas within the equivalent range should be interpreted as being included in the scope of the present disclosure.

What is claimed is:

1. A vehicle charging control apparatus, comprising:
a storage configured to store algorithms;
a processor configured, by executing the algorithms, to:
control a vehicle to pause a charging of the vehicle;
generate a discharge pulse by using a battery of the vehicle; and
control the vehicle to continue the charging of the vehicle based on the discharge pulse.

2. The vehicle charging control apparatus of claim 1, wherein the processor is configured to:
determine whether the discharge pulse exists within a target charging current provided from a charger based on a charging progress condition being satisfied.

3. The vehicle charging control apparatus of claim 2, wherein the processor is configured to:
based on the discharge pulse existing within the target charging current, pause the charging of the vehicle and generate the discharge pulse using the battery.

4. The vehicle charging control apparatus of claim 2, wherein the processor is configured to:
based on the discharge pulse existing within the target charging current, request the charger to provide the target charging current as a zero current.

5. The vehicle charging control apparatus of claim 2, wherein the processor is configured to:
request the charger to open a charger-side switch provided in the charger configured to control current supply from the charger to the vehicle.

6. The vehicle charging control apparatus of claim 1, wherein the processor is configured to:
start discharging; and
determine a target discharge current according to a discharge profile.

7. The vehicle charging control apparatus of claim 6, wherein the processor is configured to:
determine revolutions per minute (RPM) for providing the target discharge current based on current, voltage, and RPM profiles.

8. The vehicle charging control apparatus of claim 7, wherein the processor is configured to:
determine a target motor driving value for driving a motor to provide the target discharge current based on the determined RPM.

9. The vehicle charging control apparatus of claim 8, wherein the processor is configured to:
discharge an inverter and a motor based on the target motor driving value.

10. The vehicle charging control apparatus of claim 1, wherein the processor is configured to:
after generating the discharge pulse, close a switch of a pre-charge circuit for preventing an overcurrent between a battery and a charger.

11. The vehicle charging control apparatus of claim 10, wherein the processor is configured to:
provide a target charging voltage for charging to the charger; and
request the charger to open a charger-side switch provided in the charger configured to control current supply from the charger to the vehicle.

12. The vehicle charging control apparatus of claim 11, wherein the processor is configured to:
after the charge-side switch is closed, determine that a voltage and a current provided from the charger to the battery are in a stable state based on the voltage and the current being equal to or less than predetermined levels.

13. The vehicle charging control apparatus of claim 12, wherein the processor is configured to:
open the switch of the pre-charge circuit based on the voltage and the current provided from the charger to the battery being stabilized.

14. The vehicle charging control apparatus of claim 4, wherein the processor is configured to:
transfer a target charging voltage for charging to the charger, and
request constant voltage control from the charger.

15. The vehicle charging control apparatus of claim 14, wherein the processor is configured to:
request the charger to open a vehicle-side switch provided in the vehicle, the charger configured to control current supply from the charger to the vehicle.

16. The vehicle charging control apparatus of claim 15, wherein the processor is configured, after generating a discharge pulse by using the battery while the vehicle-side switch is open, to:
close the switch of the pre-charge circuit to prevent an overcurrent between the battery and the charger;
provide a target charging voltage for charging to the charger; and
request constant voltage control from the charger.

17. A system comprising:
a battery configured to provide a voltage for driving a vehicle;
a first inverter configured to provide a voltage received from a charger to the battery;
a second inverter configured to provide a voltage to the motor; and
a processor configured to:
control a vehicle to pause a charging of the vehicle;
generate a discharge pulse by using the battery of the vehicle; and
control the vehicle to continue the charging of the vehicle based on the discharge pulse.

18. The system of claim 17, wherein the vehicle includes:
a first switch provided between the battery and the first inverter; and
a second switch provided between the first inverter and the charger.

19. The system of claim 18, further comprising:
a third switch and a resistor element connected in series between the battery and the first inverter,
wherein the third switch and the resistor element are connected in parallel with the first switch.

20. A vehicle charging control method comprising:
controlling, by a processor, a vehicle to pause a charging of the vehicle;
generating, by the processor, a discharge pulse by using a battery; and
controlling, by the processor, the vehicle to continue the charging of the vehicle based on completion of generation of the discharge pulse.
